(19) United States
(12) Patent Application Publication
(10) Pub. No.: US 2019/0098983 A1
(43) Pub. Date: Apr. 4, 2019

(54) A MASKING COVER FOR A FINGER OR A TOE

(71) Applicant: REVOLUTION BY MATALON COPENHAGEN APS, Charlottenlund (DK)

(72) Inventor: Michael Balkin MATALON, Charlottenlund (DK)

(21) Appl. No.: 16/086,778

(22) PCT Filed: Mar. 6, 2017
(86) PCT No.: PCT/DK2017/050062

§ 371 Date: Sep. 20, 2018

(30) Foreign Application Priority Data
Mar. 21, 2016 (DK) PA 2016 00170

(51) Int. Cl. A45D 29/00; A45D 29/18; A61Q 3/00

(52) U.S. Cl. CPC A45D 29/004; A45D 29/22; A61Q 3/00; A45D 29/18

(57) ABSTRACT

The invention relates to a masking cover (100) for a human finger (2) or toe for protection of the human skin (4) upon application of nail polish, wherein said masking cover, in the orientation intended for use, comprises: a tubular element (6) comprising an upper surface (8) and a lower surface (10); wherein said tubular element comprising a proximal, open axial end (12) and a distal, open axial end (14); wherein the proximal, open axial end (12) is defining a proximal rim (16); wherein the distal, open axial end (14) is defining a distal rim (18); wherein said masking cover at a portion of the distal rim comprises a flap (20) extending therefrom in an axial direction and having a width (W); wherein said flap comprises a flap opening (22). The invention also relates to a cover (200) for a human hand (28) or a human foot for protection of the human skin (4) upon application of nail polish.

### FIELD OF THE INVENTION

The present invention relates in a first aspect to a masking cover for a human finger or toe for protection of the human skin upon application of nail polish. In a second aspect the present invention relates to a cover for a human hand or a human foot for protection of the human skin upon application of nail polish. In a third aspect the present invention relates to a kit comprising one or more masking covers according to the first aspect or one or more covers according to the second aspect in combination with a package containing nail polish. In a fourth aspect the present invention relates to the use of a masking cover according to the first aspect or of a cover according to the second aspect or of a kit according to the third aspect for masking off the skin of a hand or a foot, or a part thereof prior to application of nail polish. In a fifth aspect the present invention relates to a method for application of nail polish to human nails.

### BACKGROUND OF THE INVENTION

For centuries the painting of finger and/or toe nails with paint or clear varnish has been part of body decoration in most cultures, especially for women. To achieve a satisfactory result, the nail polish must be applied very carefully, since it is desirable that the nail polish covers the whole nail, and only the nail, and accordingly not the surrounding skin. Furthermore, it is desirable that the surface of the nail polish will be even and smooth and that it does not contain solidified clumps or stripes due to a brush stroke.

The achievement of such a satisfactory result is rather time-consuming.

Besides the fact that from a cosmetic standpoint it is undesirable for the applied nail polish to end up on the surrounding skin, such an imprecise application of nail polish can entail health risks, since nail polish contains solvents, chemical binders and colorants and/or pigments. Such chemical substances can penetrate the skin if the nail polish is applied inaccurately and thus be taken up by the body with negative health consequences.

In U.S. Pat. No. 5,890,495 is disclosed a glove for use during application of nail polish to finger nails or toe nails. The glove comprises five “fingers” or “toes” which at its respective ends at the area of the nail comprises a cut out pattern. The cut out pattern provides for masking part of the nail so that an ornamental pattern in the form of nail polish may be applied to the nails.

U.S. Pat. No. 5,890,495 does not disclose providing the glove with a flap extending from a distal end of each “finger” or “toe” and comprising a cut out for exposing the nail under that flap.

WO 2016/026500 A1 discloses a masking cover for a human hand or foot. The masking cover comprises a hand or foot shaped cover intended to cover a human hand or foot. The cover comprises five individual “fingers” or “toes” which at a distal end comprises an opening. The opening is having a shape which allows for exposing a finger nail or a toe nail when the cover is put on for masking off skin upon application of nail polish.

Although the masking cover disclosed in WO 2016/026500 A1 provides for an effective masking off human skin upon application of nail polish, the exact arrangement of the opening exposing the nails has turned out to be a somewhat time consuming process.

Thus, there is a need to improve masking of human skin upon application of nail polish.

It is an objective of the present invention is to provide means for such improvements.

### BRIEF DESCRIPTION OF THE INVENTION

This objective is achieved with a masking cover or a cover according to the first or second aspect of the invention; with a kit according to the third aspect of the invention; with the use according to the fourth aspect of the invention; and with a method according to the fifth aspect of the invention.

Accordingly, the first aspect of the invention relates to a masking cover for a human finger or toe for protection of the human skin upon application of nail polish, wherein said masking cover, in the orientation intended for use, comprises:

a tubular element comprising an upper surface and a lower surface;

wherein said tubular element comprising a proximal, open axial end and a distal, open axial end;

wherein the proximal, open axial end is defining a proximal rim;

wherein the distal, open axial end is defining a distal rim;

wherein said masking cover at a portion of the distal rim comprises a flap extending therefrom in an axial direction and having a width W;

wherein said flap comprises a flap opening.

The second aspect of the present invention relates to a cover for a human hand or a human foot for protection of the human skin upon application of nail polish, wherein said cover comprises:

a common element and five individual elements;

wherein said common element comprises a common tubular part having a first end and a second end;

wherein each individual element comprises a tubular part comprising an upper surface and a lower surface;

wherein said tubular part comprising a proximal end and a distal, open axial end;

wherein the first end of the tubular part of the common element is open;

wherein the second end of the tubular part of the common element is partly open;

wherein each individual element's proximal end is integrally connected to the common element's second end so as to form a passageway from the common element's first open end via the common element's second end, to each individual element's proximal end and distal end;

wherein each individual element's distal end is defining a distal rim;

wherein in respect of each individual element said individual element at a portion of the distal rim of the distal end comprises a flap extending therefrom in an axial direction and having a width W;

wherein said flap comprises a flap opening.

In a third aspect of the present invention relates to a kit comprising one or more masking covers according to the first aspect; or one or more covers according to the second aspect in combination with a package containing nail polish.

In a fourth aspect the present invention relates to a use of a masking cover according to the first aspect; or of a cover according to the second aspect; or of a kit according to the third aspect, for masking off the skin on a hand or a foot, or a part thereof prior to application of nail polish.

In a fifth aspect of the present invention relates to a method for application of nail polish to human nails, said method comprises:

i) placing a masking cover or a cover on at least part of a human finger or of a human toe, where the masking cover or the cover comprises a tubular element having a proximal axial end and having a distal open axial end with a distal rim, wherein a portion of the distal rim comprises a flap extending therefrom in an axial direction and having a width; wherein said flap comprises a flap opening;

ii) bending said flap up around the tip of the finger or the toe and bringing said flap in contact with the finger or the toe and/or with said tubular element of said masking cover or cover in such a way that the flap opening defines the circumference of the nail;

iii) making sure that the masking cover or cover is covering the skin, but not the nail;

iv) applying nail polish to the nail of the finger or toe;

v) removing said the masking cover or said cover.

The present invention in its various aspects provides for improved items and uses and methods for masking off skin upon the application of nail polish to human finger or toe nails.

### BRIEF DESCRIPTION OF THE FIGURES

FIG. 1 is a perspective view showing a masking cover according to the first aspect of the present invention.

FIG. 2 is perspective view showing a masking cover according to the first aspect of the present invention.

FIG. 3 is a perspective view showing a masking cover according to the first aspect of the present invention arranged on a human finger.

FIG. 4 is a perspective view showing a cover according to the second aspect of the present invention.

FIG. 5 is a perspective view showing a cover according to the second aspect of the present invention arranged on a human hand.

### DETAILED DESCRIPTION OF THE INVENTION

The First Aspect of the Present Invention

The first aspect of the invention relates to a masking cover for a human finger or toe for protection of the human skin upon application of nail polish, wherein said masking cover, in the orientation intended for use, comprises:

a tubular element comprising an upper surface and a lower surface;

wherein said tubular element comprising a proximal, open axial end and a distal, open axial end;

wherein the proximal, open axial end is defining a proximal rim;

wherein the distal, open axial end is defining a distal rim;

wherein said masking cover at a portion of the distal rim comprises a flap extending therefrom in an axial direction and having a width W;

wherein said flap comprises a flap opening.

The masking cover according to the first aspect of the present invention is intended for placement on the fingers or toes in such a way that the distal part of the tubular element is arranged at the finger/toe tip with the flap extending from the distal rim of the tubular element at the underside of the finger/toe tip. When placed on the finger/toe, the flap of the masking cover may be bended backward and adhered to the finger/toe. Subsequently, the flap opening is arranged in such a way that the flap opening exposes the nail, but not the skin surrounding the nail. Finally, nail polish may be applied onto the nail.

With the masking cover application of nail polish to the skin is avoided.

In the present application and in the appended claims the term “proximal end of tubular element” shall be construed to mean that end of the tubular element of the masking cover or cover, when arranged on a finger or a hand, is most proximate to the corpus of the user.

In the present application and in the appended claims the term “distal end of tubular element” shall be construed to mean that end of the tubular element of the masking cover or cover, when arranged on a finger or a hand, is most distant to the corpus of the user.

In the present application and in the appended claims the term “upper surface” shall be construed to mean the upper surface when the masking cover or cover, when covering a finger or a hand, is arranged in an orientation where the palm of the hand points downward.

In the present application and in the appended claims the term “lower surface” shall be construed to mean the lower surface when the masking cover or cover, when covering a finger or a hand, is arranged in an orientation where the palm of the hand points downward.

In one embodiment of the first aspect of the present invention, the flap is extending from the distal rim at a lower surface of the tubular element.

This will allow the flap to be bended backward so as to cover the top of the end of the finger or toe and at the same time so as to allow the flap opening to expose the nail.

In one embodiment of the first aspect of the present invention the distal rim extends upward and reward towards the proximal rim in going from a less extreme upper position on said distal rim to a more extreme upper position on said distal rim.

Hereby is achieved that the tubular element in the distal end thereof does not cover the nail of the finger or toe.

In one embodiment of the first aspect of the present invention the flap opening is extending across a portion of said width of said flap, in a direction perpendicular to an axial direction of said tubular element.

Hereby is achieved that the flap opening will easily be adapted to expose the nail but not the surrounding of a nail.

In one embodiment of the first aspect of the present invention the masking cover is having shape and dimensions so as to fit tightly on the tip of a human finger or a human toe.

A tight fit will secure the cover in place when the flap opening has been precisely arranged so as to expose the nail.

In one embodiment of the first aspect of the present invention the masking cover and/or the flap being manufactured from an elastic and/or resilient and/or stretchable material, such as a polymer, such as latex, nitrile rubber, neoprene or PVC.

Such materials have proven well-suited the intended purpose.

In one embodiment of the first aspect of the present invention the flap is being manufactured integrally with said tubular element; or wherein said flap and said tubular element are being manufactured separately and subsequent fused together, such as by gluing.

In one embodiment of the first aspect of the present invention the width W of said flap is increasing in a direction from the position of attachment to the tubular element to a distal end of said flap.

Such a design provides for improved adherence of the flap to the upper surface of the tubular element or finger or toe.

In one embodiment of the first aspect of the present invention the flap on its upper surface comprises an adhesive, and optionally furthermore a release liner protecting the adhesive; or wherein said flap on its upper surface comprises a double-sided adhesive, wherein one side is adhered to the upper surface and wherein the other side comprises a release liner.

In one embodiment of this embodiment of the first aspect of the present invention the adhesive is a pressure sensitive adhesive.

An adhesive will further improve the adherence of the flap to the upper surface of the tubular element.

In one embodiment of the first aspect of the present invention the width W of said flap is 10-45 mm, such as 15-40 mm, for example 20-35 mm or 25-30 mm.

In one embodiment of the first aspect of the present invention the length L of said flap is 15-60 mm, such as 20-55 mm, for example 25-50 mm, e.g. 30-45 mm or 35-40 mm.

In one embodiment of the first aspect of the present invention the opening of said flap is having a width w of 5-25 mm, such as 10-20 mm.

In one embodiment of the first aspect of the present invention the masking cover on its inner surface is at least partly coated with a skin conditioner.

In another embodiment of the first aspect of the present invention the masking cover is at least partly coated on its inner surface with an agent which provides a cooling sensation to the skin.

In yet another embodiment of the first aspect of the present invention the masking cover is at least partly coated on its inner surface with an agent which provides a warming sensation to the skin.

A skin conditioner will provide skin conditioning to the skin. Accordingly, while waiting on the process of application of nail polish to finish, the waiting time is used for providing skin conditioning to the skin.

In one embodiment of the first aspect of the present invention the masking cover comprises a breaking line for breaking of the material of the masking cover for the purpose of easy removal thereof.

The Second Aspect of the Present Invention

The second aspect of the present invention relates to a cover for a human hand or a human foot for protection of the human skin upon application of nail polish, wherein said cover comprises:

a common element and five individual elements;

wherein said common element comprises a common tubular part having a first end and a second end;

wherein each individual element comprises a tubular part comprising an upper surface and a lower surface;

wherein said tubular part comprising a proximal end and a distal, open axial end;

wherein the first end of the tubular part of the common element is open;

wherein the second end of the tubular part of the common element is partly open;

wherein each individual element's proximal end is integrally connected to the common element's second end so as to form a passageway from the common element's first open end via the common element's second end, to each individual element's proximal end and distal end;

wherein each individual element's distal end is defining a distal rim;

wherein in respect of each individual element said individual element at a portion of the distal rim of the distal end comprises a flap extending therefrom in an axial direction and having a width W;

wherein said flap comprises a flap opening.

The cover according to the second aspect of the present invention is used in the same way as the masking cover of the first aspect with the exception the cover is applied to the whole hand or foot instead of just the finger or toe.

In one embodiment of the second aspect of the present invention the cover is having dimensions and shape so as to fit a human right or left hand or a human right or left foot.

In one embodiment of the second aspect of the present invention the distal end of each individual element is comprising features corresponding to the distal open axial end of the tubular element as defined in respect of various embodiments of the first aspect of the present invention.

In this embodiment the distal end of each individual element of the cover simply resembles the masking cover according to the first aspect.

In one embodiment of the second aspect of the present invention the cover on its inner surface is at least partly coated with a skin conditioner.

In another embodiment of the second aspect of the present invention the cover is at least partly coated on its inner surface with an agent which provides a cooling sensation to the skin.

In yet another embodiment of the second aspect of the present invention the cover is at least partly coated on its inner surface with an agent which provides a warming sensation to the skin.

In one embodiment of the second aspect of the present invention the cover comprises a breaking line for breaking of the material of the cover for the purpose of easy removal thereof.

The Third Aspect of the Present Invention

In a third aspect of the present invention relates to a kit comprising one or more masking covers according to the first aspect; or one or more covers according to the second aspect in combination with a package containing nail polish.

In one embodiment of the third aspect of the present invention the nail polish is nail polish for application by a brush, and wherein the kit comprises a brush.

In one embodiment of the third aspect of the present invention the nail polish is nail polish for application as an aerosol spray, and wherein the package comprises an aerosol spray.

In one embodiment of the third aspect of the present invention the kit furthermore containing a nail polish remover.

In one embodiment of the third aspect of the present invention the nail polish remover contains acetone or wherein the nail polish remover is an acetone-free nail polish remover.

In one embodiment of the third aspect of the present invention the kit furthermore comprising an implement for cosmetic treatment of the nails, such as a nail file, a cuticle pusher, or the like.

The Fourth Aspect of the Present Invention

In a fourth aspect of the present invention relates to a use of a masking cover according to the first aspect; or of a cover according to the second aspect; or of a kit according to according to the third aspect, for masking off the skin on a hand or a foot, or a part thereof prior to application of nail polish.

The Fifth Aspect of the Present Invention

In a fifth aspect of the present invention relates to a method for application of nail polish to human nails, said method comprises:

i) placing a masking cover or a cover on at least part of a human finger or of a human toe, where the masking cover or the cover comprises a tubular element having a proximal axial end and having a distal open axial end with a distal rim, wherein a portion of the distal rim comprises a flap extending therefrom in an axial direction and having a width; wherein said flap comprises a flap opening;

ii) bending said flap up around the tip of the finger or the toe and bringing said flap in contact with the finger or the toe and/or with said tubular element of said masking cover or cover in such a way that the flap opening defines the circumference of the nail;

iii) making sure that the masking cover or cover is covering the skin, but not the nail;

iv) applying nail polish to the nail of the finger or toe;

v) removing said the masking cover or said cover.

In one embodiment of the fifth aspect of the present invention the method furthermore includes the following step prior to step v):

iva) waiting until the applied nail polish at least has partly dried.

In one embodiment of the fifth aspect of the present invention step iv) is performed with a brush or with an aerosol spray.

In one embodiment of the fifth aspect of the present invention the masking cover or the cover is a masking cover or a cover according to the first aspect of according to the second aspect of the present invention.

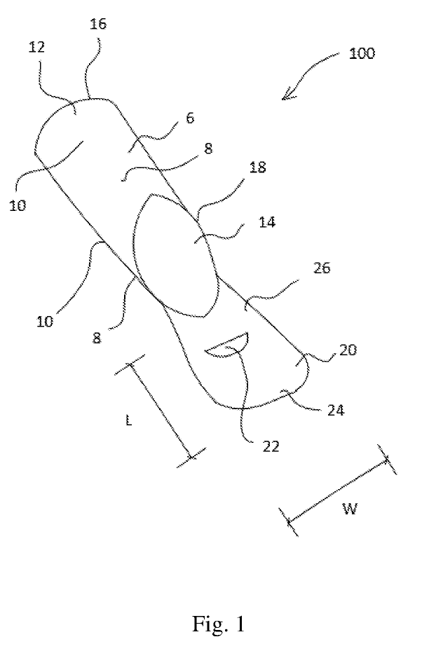

Now referring to the figures for the purpose of an illustration of the present invention, FIG. 1 shows a masking cover 100 for a human finger 2 for protection of the human skin upon application of nail polish. The masking cover, in the orientation intended for use, comprises a tubular element 6 having an upper surface 8 and a lower surface 10.

The tubular element 6 comprises a proximal, open axial end 12 and a distal, open axial end 14.

The proximal, open axial end 12 is defining a proximal rim 16. Likewise, the distal, open axial end 14 is defining a distal rim 18.

The masking cover at a portion of the distal rim 18 comprises a flap 20 extending therefrom in an axial direction. The flap 20 is having a width W.

The flap 20 comprises a flap opening 22 extending across a part of the width w of the flap.

The masking cover illustrated in FIG. 1 is ready for use and is intended for being positioned on a human finger prior to application of nail polish in such a way that the human finger is inserted into the opening defined by the proximal rim 16 and in such a way that the finger nail is exposed in the distal end 14 of the tubular element 6 of the masking cover at an upper surface thereof.

FIG. 1 also illustrates the concept of length L of the flap, which is defined as the length from the most distal part of rim 18 of the distal end of the tubular element 6 to the most distal end of the flap itself.

FIG. 1 furthermore illustrates the concept of width W of the flap, which is defined as the maximum width of the flap 20.

The flap opening 22 is intended for exposing the nail through the flap itself, when the flap 20 has been bended back towards the upper surface 8 of the tubular element 6.

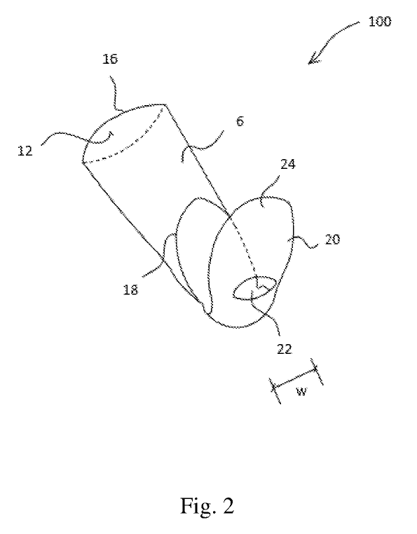

FIG. 2 illustrates a situation in which the flap of masking cover has been bent partly back over towards the upper surface 8 of the tubular element 6.

In this position the person's nail 2 (not shown in FIGS. 1 and 2) is positioned into the lower rim of the flap opening 22. Subsequently, the flap will be bended further backwards towards the upper surface 8 of the tubular element 6.

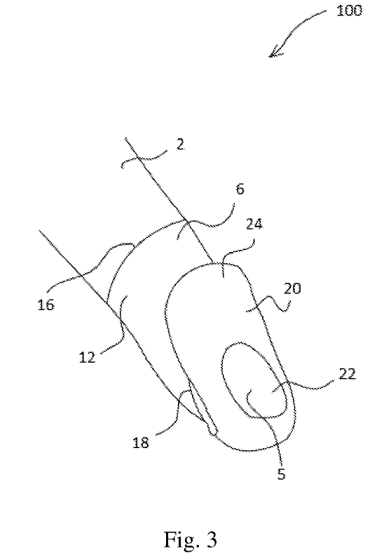

In FIG. 3 the flap 20 has been bended further backwards towards the upper surface 8 of the tubular element 6. In this position, the flap 20 only needs to be pressed against part of the skin of the finger 2 surrounding the nail 5, where after the flap will adhere to said skin or to the tubular element.

Subsequently the circumference of the flap opening 22 will be adjusted by gentle pressing onto the flap so as to follow the circumference of the nail.

When this has been accomplished, the nail is ready for application of nail polish.

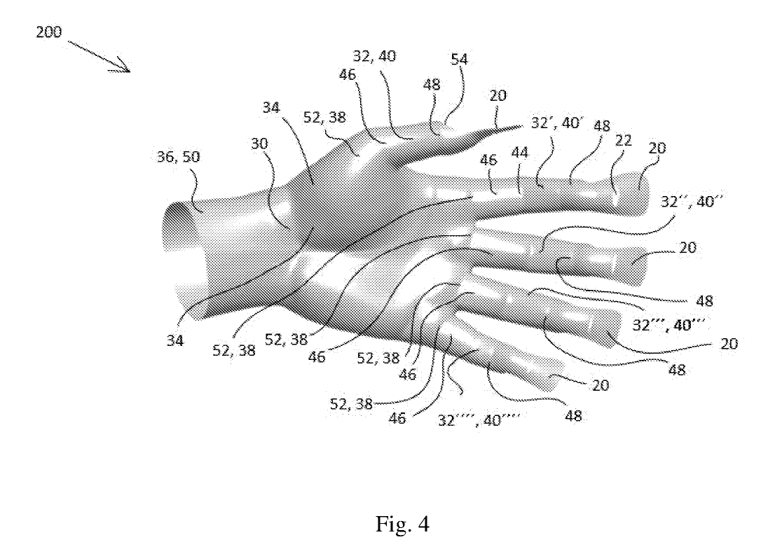

FIG. 4 is a perspective view showing a cover 200 according to the second aspect of the present invention for protection of the human skin upon application of nail polish as seen from the lower side thereof. It can be seen that the cover has the shape of a left hand glove. The cover 200 comprises a common element 30 and five individual elements 32,32′,32″,32′″,32″″;

The common element 30 comprises a common tubular part 34 having a first end 36 and a second end 38.

Each individual element 32,32′,32″,32′″,32″″ comprises a tubular part 40,40′,40″,40′′,40″″ comprising an upper surface 42 (not seen in FIG. 4) and a lower surface 44.

The tubular part 40,40′,40″,40′″,40″″ comprising a proximal end 46 and a distal, open axial end 48.

It is also seen in FIG. 4 that the first end 50 of the tubular part of the common element is open. This opening is intended for the insertion of a hand.

The second end 52 of the tubular part of the common element is partly open. This allows for a design in which each individual element's proximal end 46 is integrally connected to the common element's second end 52 so as to form a passageway from the common element's first open end 50 via the common element's second end 52, to each individual element's proximal end 46 and distal end 48.

Each of the individual element's 32,32′,32″,32′″,32″″ distal end 48 is defining a distal rim 54.

From this distal rim 54 of each individual element at a portion of that distal rim a flap 20 is extending therefrom in an axial direction. The comprises a flap opening 22.

Accordingly, the cover 200 as illustrated in FIG. 4 is intended for a cover for a human hand prior to application of nail polish. The flaps 20 with its opening 22 serves the same function as in respect of the flaps 20 and its opening 22 on the masking cover 100 according to the first aspect of the present invention and as illustrated in FIGS. 1, 2 and 3.

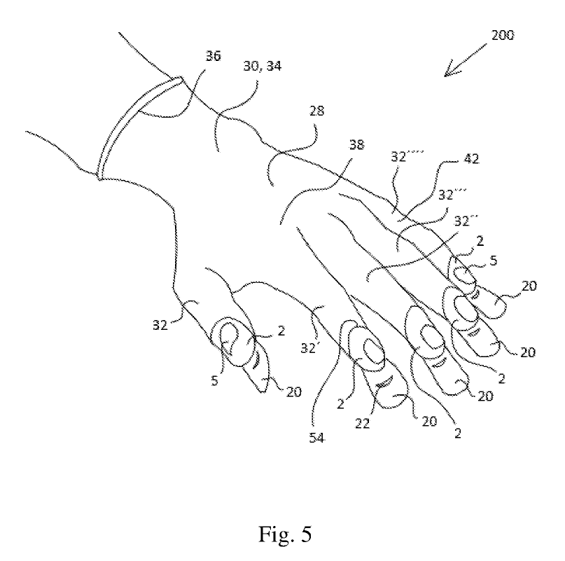

This is further illustrated in FIG. 5. FIG. 5 is perspective view showing a cover 200 according to the second aspect of the present invention which is covering a human left hand. The cover comprises the common element 30 and the five individual elements 32,32′,32″,32′″,32″″. At a distal rim 54 of each individual element 32,32′,32”,32′″,32″″ and at a lower portion thereof is extending in an axial direction a flap 20 having an opening 22.

In the situation in FIG. 5 each finger 2 is just about to be covered with the flap 20 in such a way that the circumference of the flap opening 22 covers the nail 5 of the human hand.

The cover 200 according to the second aspect of the present invention is particularly well-suited for applying nail polish to the nails by an aerosol spray.

### LIST OF REFERENCE NUMERALS

2 Human finger

4 Human skin

5 Human nail

6 Tubular element of masking cover

8 Upper surface of tubular element

10 Lower surface of tubular element

12 Proximal, open axial end of tubular element

14 Distal, open axial end of tubular element

16 Proximal rim of proximal, open axial end of tubular element

18 Distal rim of distal, open axial end of tubular element

20 Flap of masking cover or cover

22 Flap opening

24 Distal end of flap

26 Upper surface of flap

28 Human hand

30 Common element of cover

32,32′,32″ Individual element of cover

32′″,32″″ Individual element of cover

34 Common tubular part of cover

36 First end of common tubular part of cover

38 Second end of common tubular part of cover

40,40′,40″ Tubular part of individual element

40′″,40″″ Tubular part of individual element

42 Upper surface of tubular part of individual element

44 Lower surface of tubular part of individual element

46 Proximal end of tubular part of individual element

48 Distal end of tubular part of individual element

50 First end of tubular part of common element

52 Second end of tubular part of common element

54 Distal rim of distal end of individual element

100 Masking cover

200 Cover

L Length of flap

W Width of flap

w Width of opening of flap

1. A masking cover for a human finger or toe for protection of the human skin upon application of nail polish, wherein said masking cover, in the orientation intended for use, comprises:
a tubular element comprising an upper surface and a lower surface;
wherein said tubular element comprising a proximal, open axial end and a distal, open axial end;
wherein the proximal, open axial end is defining a proximal rim;
wherein the distal, open axial end is defining a distal rim;
wherein said masking cover at a portion of the distal rim comprises a flap extending therefrom in an axial direction and having a width;
wherein said flap comprises a flap opening.

2. A masking cover according to claim 1, wherein said flap extending from the distal rim at a lower surface of the tubular element.

3. A masking cover according to claim 1, wherein the distal rim extends upward and reward towards the proximal rim in going from a less extreme upper position on said distal rim to a more extreme upper position on said distal rim.

4. A masking cover according to claim 1, wherein said flap opening is extending across a portion of said width of said flap, in a direction perpendicular to an axial direction of said tubular element.

5. A masking cover according to claim 1, wherein said masking cover is having shape and dimensions so as to fit tightly on the tip of a human finger or a human toe.

6. A masking cover according to claim 1, wherein said masking cover and/or the flap being manufactured from an elastic and/or resilient and/or stretchable material, such as a polymer, such as latex, nitrile rubber, neoprene or PVC.

7. A masking cover according to claim 1, wherein said flap is being manufactured integrally with said tubular element; or wherein said flap and said tubular element are being manufactured separately and subsequent fused together, such as by gluing.

8. A masking cover according to claim 1, wherein the width of said flap is increasing in a direction from the position of attachment to the tubular element to a distal end of said flap.

9. A masking cover according to claim 1, wherein said flap on its upper surface comprises an adhesive, and optionally furthermore a release liner protecting the adhesive; or wherein said flap on its upper surface comprises a double-sided adhesive, wherein one side is adhered to the upper surface and wherein the other side comprises a release liner.

10. A masking cover according to claim 9, wherein the adhesive is a pressure sensitive adhesive.

11. (canceled)

12. A masking cover according to claim 1, wherein the length of said flap is 15-60 mm, such as 20-55 mm, for example 25-50 mm, e.g. 30-45 mm or 35-40 mm.

13. (canceled)

14. A cover for a human hand or a human foot for protection of the human skin ) upon application of nail polish, wherein said cover comprises:
a common element and five individual elements;
wherein said common element comprises a common tubular part having a first end and a second end;
wherein each individual element comprises a tubular part comprising an upper surface and a lower surface;
wherein said tubular part comprising a proximal end and a distal, open axial end;
wherein the first end of the tubular part of the common element is open;
wherein the second end of the tubular part of the common element is partly open;
wherein each individual element's proximal end is integrally connected to the common element's second end so as to form a passageway from the common element's first open end via the common element's second end, to each individual element's proximal end and distal end;
wherein each individual element's distal end is defining a distal rim;
wherein in respect of each individual element said individual element at a portion of the distal rim of the distal end comprises a flap extending therefrom in an axial direction and having a width;
wherein said flap comprises a flap opening.

15. A cover according to claim 14, wherein said cover is having dimensions and shape so as to fit a human right or left hand or a human right or left foot.

16. (canceled)

17. A cover according to claim 14, wherein the cover on its inner surface is at least partly coated with a skin conditioner.

18. A cover according to claim 17, wherein the cover is at least partly coated on its inner surface with an agent which provides a cooling sensation to the skin.

19. A cover according to claim 17, wherein the cover is at least partly coated on its inner surface with an agent which provides a warming sensation to the skin.

20. A cover according to claim 14, 19, wherein the cover comprises a breaking line for breaking of the material of the cover for the purpose of easy removal thereof.

21.-27. (canceled)

28. A method for application of nail polish to human nails, said method comprises:
i) placing a masking cover or a cover on at least part of a human finger or of a human toe, where the masking cover or the cover comprises a tubular element having a proximal axial open end and having a distal open axial end with a distal rim, wherein a portion of the distal rim comprises a flap extending therefrom in an axial direction and having a width; wherein said flap comprises a flap opening;
ii) bending said flap up around the tip of the finger or the toe and bringing said flap in contact with the finger or the toe and/or with said tubular element of said masking cover or cover in such a way that the flap opening defines the circumference of the nail;
iii) making sure that the masking cover or cover is covering the skin, but not the nail;
iv) applying nail polish to the nail of the finger or toe;
v) removing said the masking cover or said cover.

29. (canceled)

30. A method according to claim 28, wherein step iv) is performed with a brush or with an aerosol spray.

31. A method according to claim 28, where the masking cover is a masking cover according to claim 1.
